(19) United States
(12) Patent Application Publication
(10) Pub. No.: US 2002/0004822 A1
(43) Pub. Date: Jan. 10, 2002

(54) Method of vicariously executing translation of electronic mails for users, and apparatus, system and medium therefor

(75) Inventor: Tomihiko Azuma, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/899,494

(22) Filed: Jul. 5, 2001

(30) Foreign Application Priority Data
Jul. 5, 2000 (JP) 2000-204113

(51) Int. Cl. G06F 15/16

(52) U.S. Cl. 709/206; 709/245

(57) ABSTRACT

An Internet connection provider carries an electronic mail translating step of translating a part or all of the contents of an electronic mail sent from a user who is a subscriber of the Internet connection provider or an electronic mail addressed to the user. Further, a translation judging step of judging, on the basis of combination information of the mail address of the user and the mail address of a communication partner of an electronic mail which is predetermined to be translated by the user, and information on the electronic mail addresses of transmission source and destination of a user-sending electronic mail or a user-addressed electronic mail, whether the user-sending electronic mail or the user-addressed electronic mail corresponds to an electronic mail which is predetermined to be translated by the user is provided before the electronic mail translating step.

### BACKGROUND OF THE INVENTION

1. Field of the Invention

The present invention relates to a method of vicariously executing translation of electronic mail for users, and an apparatus, a system and a medium used for this method.

2. The Description of the Prior Art

Translation of electronic mails have been hitherto performed by using a method with which each user individually orders translation of electronic mails addressed thereto to a translation business dealer (that is, a translation ordering method) or a method with which each user purchases and uses software for translation by himself/herself to translate electronic mails addressed thereto (that is, a translation software using method).

The translation ordering method has such a basic disadvantage that each user must take some time to order a translation work to a translation business dealer and then receive a translated text from the dealer until the user transmits an electronic mail. Further, when each user individually orders translation to a translation business dealer, the translation cost rises up, and this offsets the cost reducing effect of trades which is obtained by using the Internet. Particularly, it is realistically substantially difficult for a personal consumer or a small-scale business dealer to employ a translator therefor on his/her own account, and thus they cannot have dealings with clients of districts or counties which would increase the translation cost.

The translation software using method has such a basic disadvantage that each user must do an extra work of preparing a translation text until he/she transmits an electronic mail. The translation software is not so high in price. However, it is not perfect in translation performance, and sufficiently satisfying translations cannot be achieved in many times. Accordingly, the users are required to have capabilities of judging whether translations are correct or not. Particularly, translations on contracts are indispensably required to be checked by experts or the like.

### SUMMARY OF THE INVENTION

According to a first aspect of the present invention, a method of vicariously translating electronic mails for users is characterized in that an Internet connection provider carries an electronic mail translating step of translating a part or all of the contents of an electronic mail sent from a user who is one of subscribers of the provider (hereinafter referred to as “user-sending electronic mail”), an electronic mail addressed to a user (hereinafter referred to as “user-addressed electronic mail”) or both of these electronic mails at the provider side.

According to a second aspect of the present invention, a provider machine (an apparatus for a provider) is characterized by including electronic mail transmitting means for transmitting a translated electronic mail containing a translation text based on a part or all of the contents of an electronic mail sent from a user who is one of subscribers of the provider, an electronic mail addressed to the user or both of these electronic mails, to a mail address of a communication partner of the electronic mail or a terminal device of the user.

According to a third aspect of the present invention, a terminal device is characterized by having translated electronic mail receiving means for receiving the translated electronic mail transmitted from the electronic mail transmitting means of the provider machine.

According to a fourth aspect of the present invention, a system is characterized by including the provider machine according to the present invention and the terminal apparatus according to the present invention.

According to a fifth aspect of the present invention, a medium is characterized by carrying a computer readable and executable program which executes of each of the steps to carry out the method of translating the electronic mail for users.

Therefore, according to the first effect of the method of vicariously translating electronic mails for users in the first aspect of the present invention, a user who is a subscriber of an Internet connection provider merely transmits an electronic mail written in a user's favorable language through the provider to a communication partner of the user with neither translating the electronic mail nor requesting the translation of the electronic mail, whereby the communication partner receive the corresponding electronic mail written in a language that the communication partner can understand. This is because the method of the first aspect of the present invention contains the translating step in which the Internet connection provider translates a part or all of the contents of the electronic mail sent from the user at the provider side.

According to the second effect of the method of vicariously executing the translation of electronic mails for users in the first aspect of the present invention, a user (a subscriber of an Internet connection provider) merely requests the provider to transmit an electronic mail, whereby the user can receive the electronic mail written in a language that the user can understand and read the electronic mail with neither translating the electronic mail nor requesting the translation thereof This is because the method of the first aspect of the present invention contains the translating step in which the Internet connection provider translates a part or all of the contents of an electronic mail addressed to the user at the provider side.

According to the first effect of the provider machine in the second aspect of the present invention, a communication partner of a user who is a subscriber of an Internet connection provider can receive an electronic mail written in a language that the communication partner can understand. This is because the provider machine of the second aspect of the present invention has the electronic mail transmitting means for transmitting a translated electronic mail containing a translation text obtained by translating a part or all of the contents of an electronic mail sent from a user (a subscriber of the provider) at the provider side to the mail address of the communication partner of the electronic mail.

According to the second effect of the provider machine of the second aspect of the present invention, a user (a subscriber of an Internet connection provider) can receive an electronic mail written in a language that the user can understand, and read the electronic mail with neither translating the electronic mail nor requesting the translation thereof This is because the provider machine of the second aspect of the present invention has the electronic mail transmitting means for transmitting the translated electronic mail containing the translation text obtained by translating a part or all of the contents of the electronic mail addressed to the user at the provider side to the terminal device of the user.

According to the effect of the terminal device of the third aspect of the present invention, an translated electronic mail containing a translation text obtained by translating a part or all of the contents of an electronic mail sent from a user (a subscriber of an Internet connection provider) at the provider side, or a translated electronic mail containing a translation text obtained by translating a part or all of the contents of an electronic mail addressed to a user (a subscriber of an Internet connection provider) at the provider side can be received. This is because the terminal device of the third aspect of the present invention has at least the translated electronic mail receiving means for receiving the translated electronic mail transmitted from the electronic mail transmitting means of the provider machine of the present invention.

According to the effect of the system according to the fourth aspect of the present invention, both of the effect of the provider machine and the effect of the terminal device of the present invention can be achieved. This is because the system of the fourth aspect of the present invention contains the provider machine of the present invention and the terminal device of the present invention.

### BRIEF DESCRIPTION OF THE DRAWINGS

FIG. 1 is a block diagram showing an embodiment of a provider machine according to the present invention;

FIG. 2 is a block diagram when the provider machine is an information processor such as a computer or the like;

FIG. 3 is a block diagram showing an embodiment of the present invention;

FIG. 4 is a flowchart showing the operation of the embodiment;

FIG. 5 is a flowchart showing the operation of the embodiment; and

FIG. 6 shows an example of translation information stored by an Internet connection provider 20.

### DETAILED DESCRIPTION OF THE PREFERRED EMBODIMENT

A preferred embodiment according to the present invention will be described hereunder with reference to the accompanying drawings. [Method of vicariously executing translation of an electronic mail sent from user]

The user-sending electronic mail translating step according to this method can be set to a step in which an Internet connection provider translates a part of or all of the contents of an electronic mail sent from a user serving as a subscriber of the provider to a communication partner by utilizing any one or both of a translating machine and a translator.

According to this method, a step of transmitting a translated electronic mail containing a translation text of a part or all of the contents of the electronic mail translated in the user-sending electronic mail translating step through the Internet to the mail address of a communication partner of the electronic mail by the provider can be carried out after the user-sending electronic mail translating step. The user-sending electronic mail translated at the provider side may be set as an electronic mail which is predetermined to be transmitted to a specific communication partner by the user. [Method of vicariously executing translation of an electronic mail addressed to user]

The user-addressed electronic mail translating step of this method may be set to a step in which an Internet connection provider translates a part or all of the contents of an electronic mail addressed to a user (a subscriber of the provider), which is received through the Internet, by utilizing any one or both of a translating machine and a translator.

According to this method, an user-addressed electronic mail transmitting step of transmitting a translated electronic mail containing a translation text of a part or all of the contents of the electronic mail translated in the user-addressed electronic mail translating step to the terminal of the user in response to a request from the user can be carried out after the user-addressed electronic mail translating step. The user-addressed electronic mail to be translated at the provider side may be set as an electronic mail from a specific communication partner predetermined by the user.

The method of vicariously executing translation of translating electronic mails for users according to the present invention may be set as follows.

The language of the user-sending electronic mail or the user-addressed electronic mail translated at the provider side for a transmission destination may be set to a language that is settled by the user in advance. A mail address acquiring step of acquiring the electronic mail address of a transmission source and the electronic mail address of a transmission destination from the user-sending electronic mail or the user-addressed electronic mail may be carried out before the user-sending electronic mail translating step or the user-addressed electronic mail translating step.

Further, a step of judging whether translation is needed or not (hereinafter referred to as “translation judging step”) may be provided before the user-sending electronic mail translating step or the user-addressed electronic mail translating step. In the translation judging step, on the basis of combination information of the mail address of the user and the mail address of the communication partner of the electronic mail which is predetermined by the user to be translated, and the information on the electronic mail address of the transmission source and the electronic mail address of the transmission destination which are acquired in the mail address acquiring step, it is judged whether the user-sending electronic mail or the user-addressed electronic mail corresponds to the electronic mail which is predetermined by the user to be translated. For example, by collating the electronic mail address information of the transmission source and transmission destination acquired in the mail address acquiring step with the combination information, it can be judged whether the electronic mail targeted to find the information of the electronic mail address of the transmission source and transmission destination in the mail address acquiring step corresponds to an electronic mail to be translated.

[Provider Machine]

A provider machine of the present invention will be described with reference to the accompanying drawings.

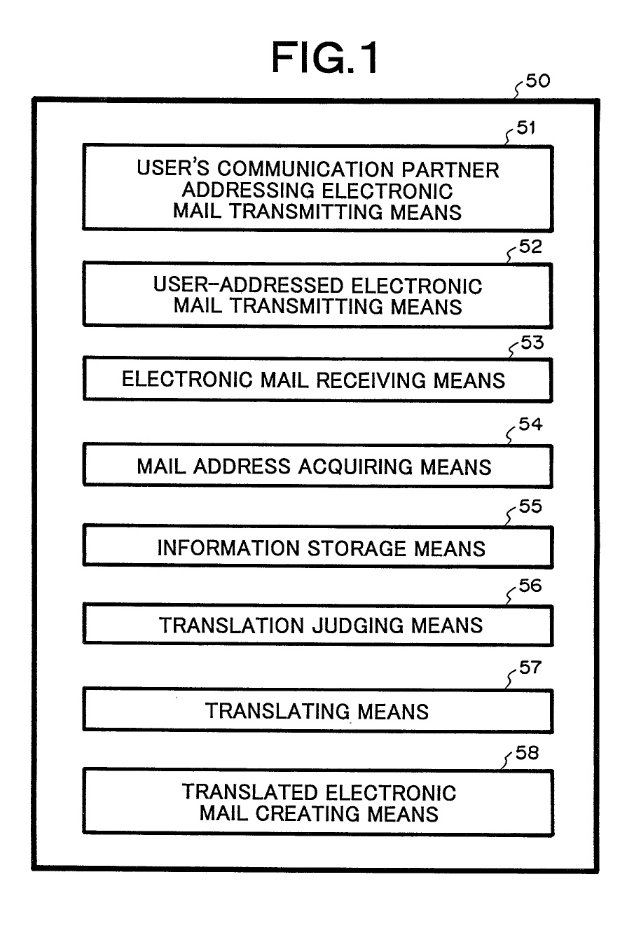

FIG. 1 is a block diagram showing an embodiment of the provider machine according to the present invention.

Provider machine 50 is equipped with user's communication partner addressing-electronic mail transmitting means 51. The user's communication partner addressing-electronic mail transmitting means 51 transmits a translated electronic mail containing a translation text of a part or all of the contents of an electronic mail sent from a user (a subscriber of an Internet connection provider) to the mail address of a communication partner of the electronic mail through the Internet, the translation text being created at the provider side. The electronic mail sent from the user may be set as an electronic mail to be transmitted to a specific communication partner predetermined by the user.

The provider machine 50 is equipped with user-addressed electronic mail transmitting means 52. The user-addressed electronic mail transmitting means 52 transmits a translated electronic mail containing a translation text of a part or all of the contents of an electronic mail addressed to a user (a subscriber of an Internet connection provider) to a terminal device of the user in accordance with the user's request, the electronic mail being received through the Internet by the provider and the translation text being created by the provider. The electronic mail addressed to the user may be set as an electronic mail from a specific communication partner which is predetermined by the user.

The language of the user-sending electronic mail or the user-addressed electronic mail for a translation destination may be set to a language predetermined by the user. The provider machine 50 has electronic mail receiving means 53 for receiving the user-sending electronic mail or the user-addressed electronic mail, and mail address acquiring means 54 for acquiring the electronic mail address of a transmission source and the electronic mail address of a transmission destination on the basis of the user-sending electronic mail or user-addressed electronic mail received by the electronic mail receiving means 53.

The provider machine 50 is equipped with information storing means 55 for storing combination information on the mail address of the user, the mail address of the communication partner of the electronic mail which is predetermined by the user to be translated, and the language to the translation destination, and translation judging means 56 for judging whether the electronic mail sent from the user or the electronic mail addressed to the user corresponds to an electronic mail which is predetermined by the user to be translated, on the basis of the electronic mail address of the transmission source and the electronic mail address of the transmission destination acquired by the mail address acquiring means 54 and the combination information of the information storage means 55.

Further, the provider machine 50 is equipped with translating means 57 for translating a part or all of the contents of the user-sending electronic mail or the user-addressed electronic mail into the language for the translation destination on the basis of the combination information of the information storage means 55, and translated electronic mail creating (preparing) means 58 for creating (preparing) a translated electronic mail containing a translation text translated by the translating means 57.

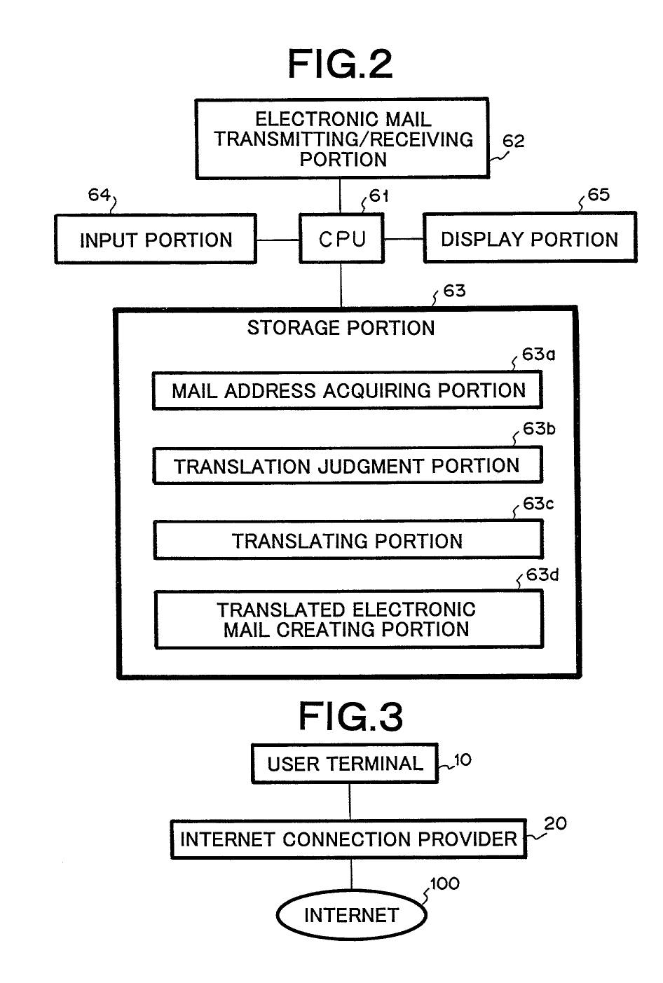

Next, the provider machine will be described in detail with reference to FIG. 2 by exemplifying a case where it is an information processor such as a computer.

FIG. 2 is a block diagram showing an information processor such as a computer which is an embodiment of the provider machine.

The provider machine includes CPU (Central Processing Unit) 61, electronic mail transmitting/receiving portion 62, storage portion 63, input portion 64 and display portion 65. The electronic mail transmitting/receiving portion 62 is information transmitting/receiving means such as a modem, and it also acts as the user's communication partner addressing-electronic mail transmitting means 51, the user-addressed electronic mail transmitting means 52 and the electronic mail receiving means 53. The electronic mail transmitting/receiving portion 62 can receive the user-sending electronic mail and the user-addressed electronic mail. The storage portion 63 is an information storage medium such as a memory, a hard disk or the like.

The storage portion 63 stores the electronic mail transmitted/received by the electronic mail transmitting/receiving portion 62, and the combination information on the mail address of the user, the mail address of the communication partner of the electronic mail to be translated which is predetermined by the user, and the language to the translation destination. Further, the storage portion 63 is equipped with mail address acquiring portion 63a for storing the mail address acquiring means 54 as a program, translation judging portion 63b for storing the translation judging means 56 as a program, translating portion 63c for storing the translating means 57 as a program, and translated electronic mail creating portion 63d for storing the translated electronic mail creating (preparing) means 58 as a program. The storage portion 63 stores information such as programs needed to operate the provider machine.

The input portion 64 is information input means such as a keyboard, and can perform an information input operation. The display portion 65 is display means such as a liquid crystal display, CRT (cathode ray tube) or the like, and it can display information stored in the storage portion 63, for example.

[Terminal Device]

The terminal device may be a terminal device having at least translated electronic mail receiving means for receiving a translated electronic mail transmitted from the provider machine through the Internet, for example, a terminal device which is connected to a network to transmit/receive information such as an electronic mail, for example. It includes CPU (Central Processing Unit), an information transmitting/receiving portion of electronic mails or the like, a storage portion, an input portion and a display portion. The information transmitting/receiving portion is information transmitting/receiving means such as a modem. The storage portion is an information recording medium such as a memory, a hard disk or the like, and it can store information such as an electronic mail transmitted/received by the information transmitting/receiving portion.

[Medium]

Any medium may be used insofar as programs can be recorded therein. For example, it may be a magnetic disk, a magnetic tape, a magneto-optical disk, CD-ROM, a semiconductor memory or other recording media.

According to the present invention, the Internet connection provider which supplies electronic mail functions to users executes translation of electronic mails in stead of the users, whereby even when a transmission source and a transmission destination of an electronic mail use different languages, the correct information transmission can be performed between the transmission source and the transmission destination.

An example of the present invention will be described with reference to FIG. 3.

FIG. 3 is a block diagram showing the example of the present invention. In FIG. 3, a user is a subscriber of Internet connection provider 20, and an electronic mail address is allocated to the user by the Internet connection provider 20. The user is connected to the Internet connection provider 20 by using user terminal 10, and transmits to the Internet connection provider 20 an electronic mail which is made in a language used by himself/herself. The Internet connection provider 20 receives the electronic mail from the user terminal 10, translates the electronic mail thus received to a translation text in a language used by a person who is indicated as a transmission destination of the electronic mail by the user, and then transmits the translated electronic mail through Internet 100 to the transmission destination of the electronic mail.

On the other hand, when an electronic mail addressed to a user is distributed through the Internet 100 to the Internet connection provider 20, the Internet connection provider 20 translates the electronic mail from the text in the language used by the transmitter to the text in the language used by the receiver (user). The user connects to the Internet connection provider 20 by using the user terminal 10, and receives the electronic mail which has been translated in the language used by the user.

[Embodiment]

Referring to FIG. 3, an embodiment of the provider machine used for the method of vicariously executing translation of electronic mails for users is an information processor such as a server/computer or the like of the Internet connection provider 20, and the user terminal 10 can be connected to the provider machine and also it can be connected to the Internet 100 through the provider machine.

The user terminal 10 has a function of connecting through the Internet connection provider 20 to the Internet 100, and it is a cellular phone, a portable information terminal, a personal computer or the like. The user terminal 10 also has a function of transmitting/receiving electronic mails through the Internet connection provider 20, and also it can be mutually connected to the Internet connection provider 20 in a wired or wireless style.

The Internet connection provider 20 supplies pre-registered users with transmission/reception services of electronic mails to the Internet 100, and it is constructed by an information processor such as a server. The transmission/reception services of electronic mails through the Internet connection provider 20 to the Internet 100 can be used by only the users which are registered in advance.

The Internet connection provider 20 has a function of allocating an electronic mail address to each user and storing information to perform proper translation every communication partner. As a method of storing the information needed for translation is available a method of storing a pair of the electronic mail address of a subscriber pre-registered as a user and a using language, and a pair of the electronic mail address of a communication partner and a using language while the pairs are associated with each other. The internet connection provider 20 has a function of properly translating electronic mails transmitted/received in various languages. For example, an automatic translation based on software or the like, a manual translation of a translator or the combination thereof is available as the translating method.

The Internet connection provider 20 has a function of translating an electronic mail which a user sends by using a user terminal 10 so that an addressed communication partner can read the electronic mail, and then transmitting the electronic mail thus translated to the Internet 100.

The Internet connection provider 20 also has a function of translating an electronic mail received from the Internet 100 so that a subscriber can read the electronic mail, and then storing the electronic mail thus translated. The Internet connection provider 20 has a further function of distributing the translated electronic mail to a user terminal when a user requests a received electronic mail to the user by the user terminal 10.

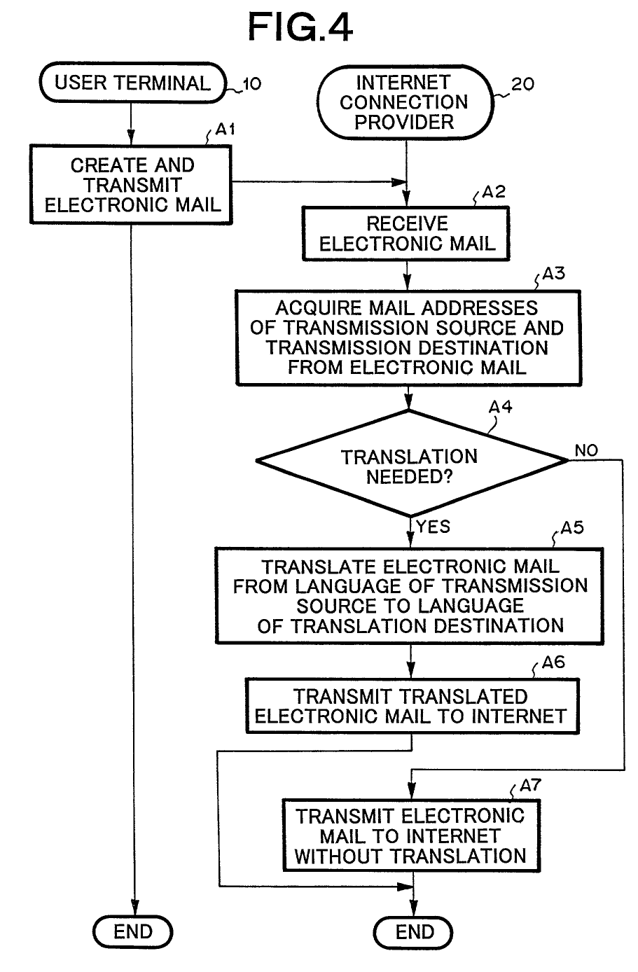

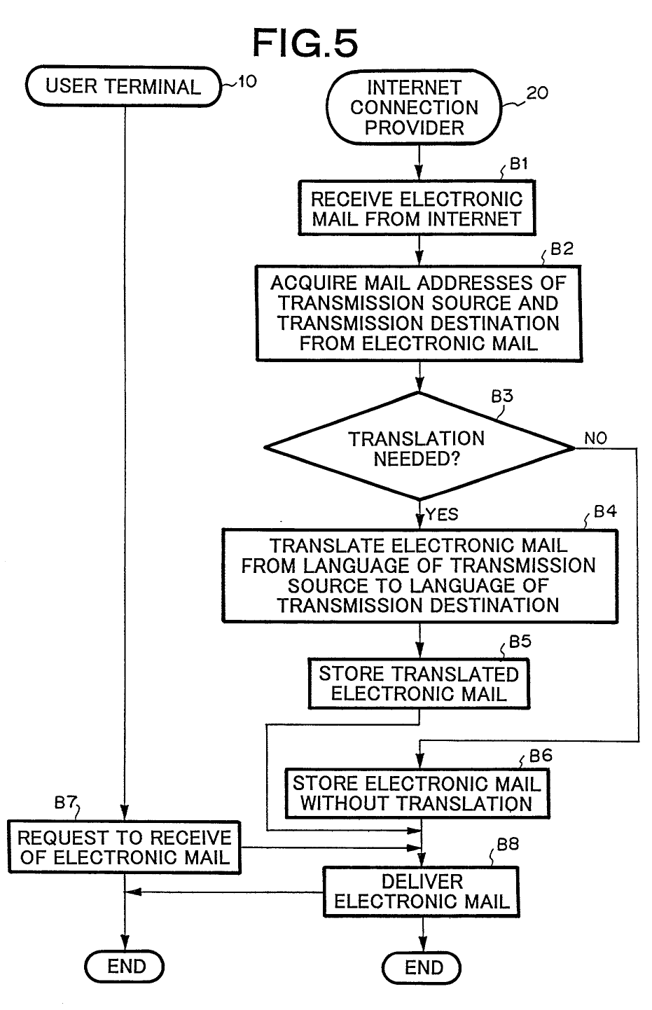

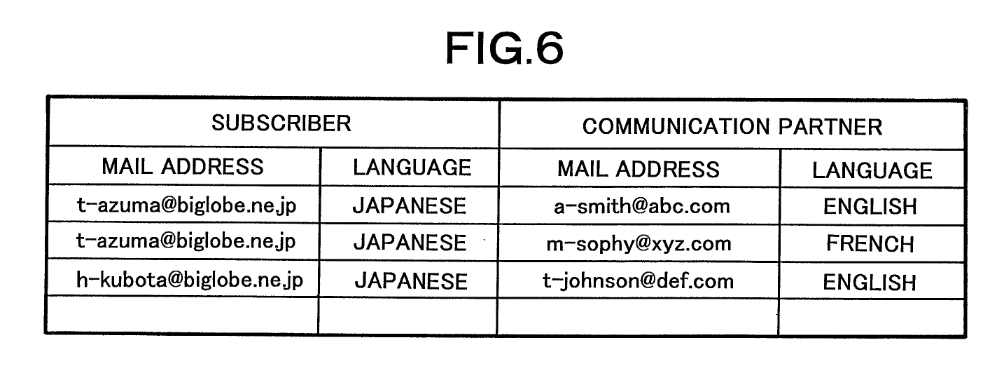

Next, the operation of the embodiment according to the present invention will be described in detail with reference to FIGS. 3, 4, 5 and 6. FIGS. 4 and 5 are flowcharts showing the operation of the embodiment. FIG. 6 shows an example of translation information stored in the Internet connection provider 20.

First, the operation when an electronic mail is transmitted from the user terminal 10 will be described in detail with reference to FIG. 4.

The user creates an electronic mail in a normally using language by using the user terminal 10 and then transmits the electronic mail to the Internet connection provider 20 (step A1). The Internet connection provider 20 receives the electronic mail (step A2), and acquires the electronic mail address of a transmission source and the electronic mail address of a transmission destination on the basis of the electronic mail thus received (step A3).

Next, the Internet connection provider 20 uses the electronic mail address of the transmission source and the electronic mail address of the transmission destination to judge whether the translation of the electronic mail is needed or not.

In the table of FIG. 6, except for the headline, the first line represents that in the communication between a subscriber of “t-azuma@biglobe.ne.jp” and “a-smith@abc.com”, “t-azuma@biglobe.ne.jp” uses Japanese and “a-smith@abc.com” uses English. Likewise, the second line represents that that in the communication between a subscriber of “t-azuma@biglobe.ne.jp” and “m-sophy@xyz.com”, “t-azuma@biglobe.ne.jp” uses Japanese and “m-sophy@xyz.com” uses French. Further, the third line represents that that in the communication between a subscriber of “h-kubota@biglobe.ne.jp” and “t-johnson@defcom”, “h-kubota@biglobe.ne.jp” uses Japanese and “t-johnson@def com” uses English.

In step A4, if the pair of the mail addresses of the transmission source and the transmission destination are found in the translation information of FIG. 6, it is judged that the translation is needed. If not so, it is judged that the translation is not needed. If the translation of the electronic mail is judged to be needed, the electronic mail is translated from the language of the transmission source to the language of the transmission destination by using the translation information of FIG. 6 (step A5). For example, when the transmission source is “t-azuma@biglobe.ne jp” and the transmission destination is “a-smith@abc.com”, the translation is made from Japanese into English. When the transmission source is “t-azuma@biglobe.ne.jp” and the transmission destination is “m-sophy@xyz.com”, the translation is made from Japanese into French.

After the translation is finished, the Internet connection provider 20 transmits the translated electronic mail to the Internet 100 (step A6). If it is judged in the step A4 that the translation is not needed, the Internet connection provider 20 does not execute the translation of the electronic mail, and the electronic mail created in the user terminal 10 by the user is directly transmitted to the Internet 100 (step A7).

Next, the operation when the electronic mail from the Internet 100 is received will be described in detail with reference to FIG. 5. The Internet connection provider 20 receives an electronic mail from the Internet 100 (step B1), and acquires the electronic mail address of a transmission source and the electronic mail address of a transmission destination from the electronic mail (step B2).

Subsequently, the Internet connection provider 20 uses the electronic mail address of the transmission source and the electronic mail address of the transmission destination to judge whether the translation of the electronic mail is needed or not (step B3). Like the step A4, in step B3, if the pair of the mail addresses of the transmission source and the transmission destination is found in the translation information of FIG. 6, it is judged that the translation is needed. If not so, it is judged that the translation is not needed.

If it is judged that the translation of the electronic mail is needed, the electronic mail is translated from the language of the transmission source into the language of the transmission destination by using the translation information of FIG. 6 (step B4). For example, when the transmission source is “a-smith@abc.com” and the transmission destination is “t-azuma@biglobe.ne.jp”, the electronic mail is translated from English into Japanese. When the transmission source is “m-sophy@xyz.com” and the transmission destination is “t-azuma@biglobe.ne.jp”, the electronic mail is translated from French into Japanese.

After the translation is finished, the Internet connection provider 20 stores the translated electronic mail therein (step B5). If it is judged in step B3 that the translation is not needed, the Internet connection provider 20 does not execute the translation of the electronic mail, and stores the electronic mail received from the Internet 100 (step B6).

The user requests reception of the electronic mail to the Internet connection provider 20 by using the user terminal 10 (step B7), and the Internet connection provider 20 transmits the electronic mail stored therein to the user terminal 10 (step B8).

A first effect of the embodiment resides in that any user can make communications with various foreign people in the world through electronic mails by using his/her familiar language. Particularly, consumers and business dealers in the world participate in the rapidly propagating electronic commercial trading market, and confirmation of contract contents, management to inquiries/claims, etc. are frequently carried out on the basis of electronic mails. However, there occurs such a case that one party of a trade cannot understand an electronic mail from the other party because of the difference in degree of skill to the language. Particularly, with respect to the management to the claims, etc., information to be transmitted is more complicated than information when goods are purchased, and thus the skill degree to the language has a great effect. In the worst case, a party who suffers damages due to inadequate information transmission may file a suit for the damages.

The present invention is remarkably effective to enable the electronic trades to be carried out in the languages with which the users are familiar. This is because the Internet connection provider having a connection point with the Internet enables bi-directional translation based on user's instruction.

A second effect of the embodiment resides in that users can reduce the translation cost of electronic mails. This is because if the Internet connection provider collectively carries out translations, the translation cost per user can be more reduced as compared with a case where an individual user requests translation of an electronic mail to a translator. Further, it is unnecessary to install a specific software or a device into the user terminal for transmitting/receiving electronic mails.

A third effect of the embodiment resides in that any user can make communications with people in the world in various languages by using a terminal which supports only one language. Particularly, a cellular phone, a portable information terminal, etc. have a function of dealing only specific language, and the number of these devices which have been already shipped is huge. Therefore, the effect of the present invention is remarkable. This is because it is unnecessary to make an alteration (modification) at the user terminal side because the Internet connection provider executes vicariously the translation work of the electronic mail for users.

What is claimed is:

1. A method of vicariously executing translation of electronic mails for users, comprising a translating step of translating a part or all of the contents of an electronic mail sent from a user who is a subscriber of an Internet connection provider, an electronic mail addressed to the user or both of these electronic mails at the provider side.

2. The method as claimed in claim 1, further comprising a translation judging step of judging whether the user-sending or user-addressed electronic mail corresponds to an electronic mail which is predetermined by the user to be translated, on the basis of combination information of the mail address of the user and the mail address of a communication partner of an electronic mail which is predetermined by the user to be translated, and information on the electronic mail addresses of the transmission source and destination of a user-sending electronic mail or a user-addressed electronic mail, said translation judging step being antecedent to said electronic mail translating step.

3. A provider machine comprising electronic mail transmitting means for transmitting, to the mail address of a communication partner of an electronic mail or a terminal device of the user, a translated electronic mail containing a translation text obtained by translating through the provider a part or all of the contents of an electronic mail sent from a user who is a subscriber of an Internet connection provider, an electronic mail addressed to the user or both of these electronic mails.

4. The provider machine as claimed in claim 3, further comprising:
information storage means for storing at least combination information of the mail address of the user and the mail address of a communication partner of an electronic mail which is predetermined by the user to be translated; and
translation judging means for judging whether the user-sending or user-addressed electronic mail corresponds to the electronic mail which is predetermined by the user to be translated, on the basis of the electronic mail addresses of a transmission source and a transmission destination of a user-sending electronic mail or user-addressed electronic mail and the combination information of said information storage means.

5. The provider machine as claimed in claim 3, further comprising:
information storage means for storing combination information of the mail address of the user, the mail address of a communication partner which is predetermined by the user to be translated, and a language for a translation destination;
translating means for translating a part or all of the contents of an electronic mail sent from the user or addressed to the user in the language of the translation destination on the basis of the combination information of said information storage means; and
translated electronic mail creating means for creating a translated electronic mail containing a translated text translated by said translating means.

6. The provider machine as claimed in claim 4, further comprising:
another information storage means for storing combination information of the mail address of the user, the mail address of a communication partner which is predetermined by the user to be translated, and a language for a translation destination;
translating means for translating a part or all of the contents of an electronic mail sent from the user or addressed to the user in the language of the translation destination on the basis of the combination information of said another information storage means; and
translated electronic mail creating means for creating a translated electronic mail containing a translated text translated by said translating means.

7. A terminal device comprising at least translated electronic mail receiving means for receiving a translated electronic mail transmitted from said electronic mail transmitting means of said provider machine as claimed in claim 3.

8. A system comprising said provider machine as claimed in claim 3, and said terminal device as claimed in claim 7.

9. A medium for carrying a computer readable and executable program for executing said translating step in the electronic mail translating method as claimed in claim 1.

10. A medium for carrying a computer readable and executable program for executing said translation judging step in the electronic mail translating method as claimed in claim 2.
